(19) United States
(12) Patent Application Publication
(10) Pub. No.: US 2017/0116087 A1
(43) Pub. Date: Apr. 27, 2017

(54) STORAGE CONTROL DEVICE

(71) Applicant: FUJITSU LIMITED, Kawasaki-shi (JP)

(72) Inventor: Yasuyuki Nakata, Kawasaki (JP)

(73) Assignee: FUJITSU LIMITED, Kawasaki-shi (JP)

(21) Appl. No.: 15/281,581

(22) Filed: Sep. 30, 2016

(30) Foreign Application Priority Data
Oct. 23, 2015 (JP) 2015-208728

(51) Int. Cl. G06F 11/14

(52) U.S. Cl. CPC G06F 11/1451; G06F 11/1453; G06F 11/1464; G06F 11/1469; G06F 2201/84

(57) ABSTRACT

A storage control device includes a memory and a processor coupled with the memory. The processor is configured to: perform a deduplication process for avoiding duplication of first unit data among unit data of a deduplication volume in a storage device on basis of map information for the deduplication volume upon receiving a write request for writing write data to a write destination in the first unit data. Each unit data of the deduplication volume is allocated with a logical area. The map information includes an entry corresponding to each unit data of the deduplication volume. The entry indicates a physical area allocated to the logical area of each unit data. The processor is configured to: create, upon receiving a request for creating a snapshot of the deduplication volume, the snapshot by copying the map information into a snapshot area.

### CROSS-REFERENCE TO RELATED APPLICATION

This application is based upon and claims the benefit of priority of the prior Japanese Patent Application No. 2015-208728, filed on Oct. 23, 2015, the entire contents of which are incorporated herein by reference.

### FIELD

The embodiment discussed herein is related to a storage control device.

### BACKGROUND

With an increase in data amount handled in business and the spread of virtual environments, storage devices required to be used is being increased significantly. Therefore, a storage system may use a data deduplication function of a storage control device in order to reduce the data amount. When the data deduplication function is used, only one physical data area is allocated to plural data having identical contents. The storage is a drive such as a hard disk drive (HDD), a solid state drive (SSD), or the like.

The storage system may use a snapshot creation function to gather and create, as a snapshot, an image of a copy source volume on a storage at a specific time point. In the creation of the snapshot, a management area (snapshot area) is secured, and no copy of real data of the copy source volume is performed. When a data update is performed to the copy source volume by a server, corresponding pre-update data is copied to the management area in the case where the pre-update data is not copied yet.

Related technologies are disclosed in, for example, Japanese Laid-Open Patent Publication No. 2013-47933 and Japanese Laid-Open Patent Publication No. 11-134117.

### SUMMARY

According to an aspect of the present invention, provided is a storage control device including a memory and a processor coupled with the memory. The processor is configured to: perform a deduplication process for avoiding duplication of first unit data among unit data of a deduplication volume in a storage device on basis of map information for the deduplication volume upon receiving a write request for writing write data to a write destination in the first unit data. Each unit data of the deduplication volume is allocated with a logical area. The map information includes an entry corresponding to each unit data of the deduplication volume. The entry indicates a physical area allocated to the logical area of each unit data. The processor is configured to: create, upon receiving a request for creating a snapshot of the deduplication volume, the snapshot by copying the map information into a snapshot area.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an exemplary hardware configuration of a storage system including a storage control device according to an embodiment;

FIG. 2 is a diagram illustrating an exemplary functional configuration of a storage control device according to an embodiment;

FIGS. 3A and 3B are diagrams illustrating exemplary block maps for two different deduplication volumes (logical volumes), respectively;

FIG. 4 is a diagram illustrating a snapshot creation operation according to an embodiment;

FIGS. 5A and 5B are diagrams illustrating examples of a block map for a deduplication volume and a block map as a snapshot of the deduplication volume, respectively, to explain a snapshot creation operation according to an embodiment;

FIGS. 6A and 6B are diagrams illustrating examples of a block map for a deduplication volume and a block map as a snapshot of the deduplication volume, respectively to explain a snapshot creation operation according to an embodiment;

FIGS. 7A and 7B are diagrams illustrating examples of a block map for a deduplication volume and a block map as a snapshot of the deduplication volume, respectively, to explain a snapshot creation operation according to an embodiment;

FIG. 8 is a diagram illustrating an example of a bit map corresponding to the block map illustrated in FIG. 7B to explain a snapshot creation operation according to an embodiment;

FIG. 9 is a diagram illustrating a restoration operation according to an embodiment;

FIGS. 10A and 10B are diagrams illustrating examples of a block map for a deduplication volume and a block map as a snapshot of the deduplication volume, respectively, to explain a restoration operation according to an embodiment;

FIGS. 11A and 11B are diagrams illustrating examples of a block map for a deduplication volume and a block map as a snapshot of the deduplication volume, respectively, to explain a restoration operation according to an embodiment;

FIG. 12 is a flowchart illustrating a flow of operations for storage control according to an embodiment;

FIG. 13 is a flowchart illustrating a flow of a process performed upon receiving a snapshot creation request according to an embodiment;

FIG. 14 is a flowchart illustrating a flow of a process performed upon receiving a write request in an existing storage system;

FIG. 15 is a flowchart illustrating a flow of a process performed upon receiving a write request according to an embodiment;

FIG. 16 is a flowchart illustrating a flow of a process performed upon receiving a read request according to an embodiment; and

FIG. 17 is a flowchart illustrating a procedure for performing both a data deduplication process and a snapshot creation process in an existing storage system.

### DESCRIPTION OF EMBODIMENT

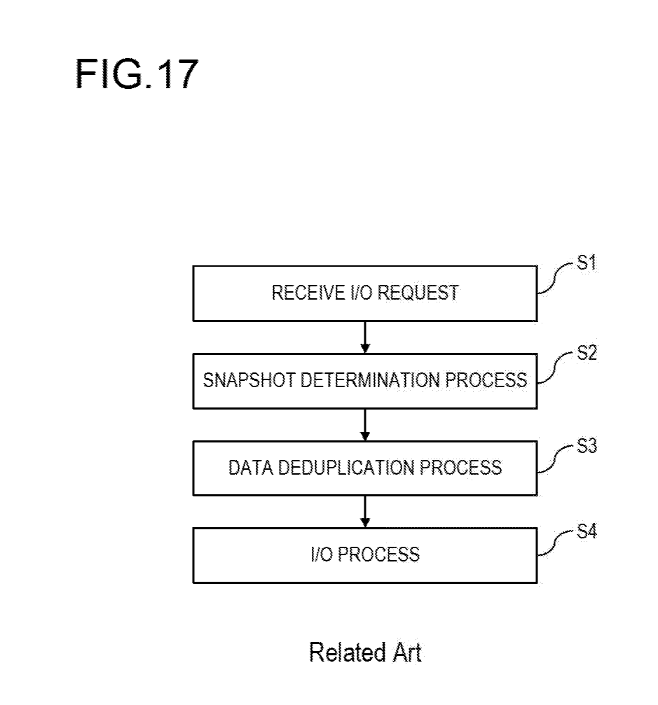

The above-described data deduplication process and snapshot creation process have a similar idea in that different physical areas are not allocated to plural data having identical contents, although these processes are different from each other in situations used. In the present situation, the above-described data deduplication process and snapshot creation process are not cooperative with each other but are controlled independently as illustrated in, for example, FIG. 17. FIG. 17 is a flowchart illustrating a procedure for performing both the data deduplication process and the snapshot creation process in an existing storage system.

As illustrated in FIG. 17, in the storage system, when an input/output (I/O) request for a copy source volume is received from a server (S1), a snapshot determination process is first performed (S2). When the received I/O request is a data update request (write request) for the copy source volume, it is checked in the snapshot determination process whether or not pre-update data in the copy source volume is already copied. As a result of the checking, when the pre-update data in the copy source volume is not copied yet, a process of evacuating the pre-update data to a management area (snapshot area) is performed. Such a process is an overhead in the snapshot creation process.

In the data deduplication process (S3) performed thereafter, when the received I/O request is a data update request for the copy source volume, a duplication check is performed as to whether or not post-update data overlaps with existing data. Then, after the data deduplication process is performed in accordance with a result of the duplication check, an I/O process (S4) is performed in accordance with the I/O request. When the post-update data overlaps with existing data, a logical area of the object data of the I/O request is associated with a physical area of the existing data. When the post-update data does not overlap with existing data, the logical area of the object data of the I/O request is associated with a newly allocated physical area. The above-described duplication check process is an overhead in the data deduplication process.

As described above with reference to FIG. 17, when the snapshot creation function and the data deduplication function are simply combined with each other, the above-described two overheads are simply added to each other, thereby deteriorating the storage performance.

Hereinafter, an embodiment of the storage control device of the present disclosure will be described with reference to the drawings. However, the following embodiment is merely illustrative only and is not intended to exclude application of various modifications and techniques which are not specified in the embodiment. In other words, the embodiment may be variously modified within a scope that does not depart from the gist of the embodiment. Each of the drawings is not intended to include only components illustrated therein, and may include other functions.

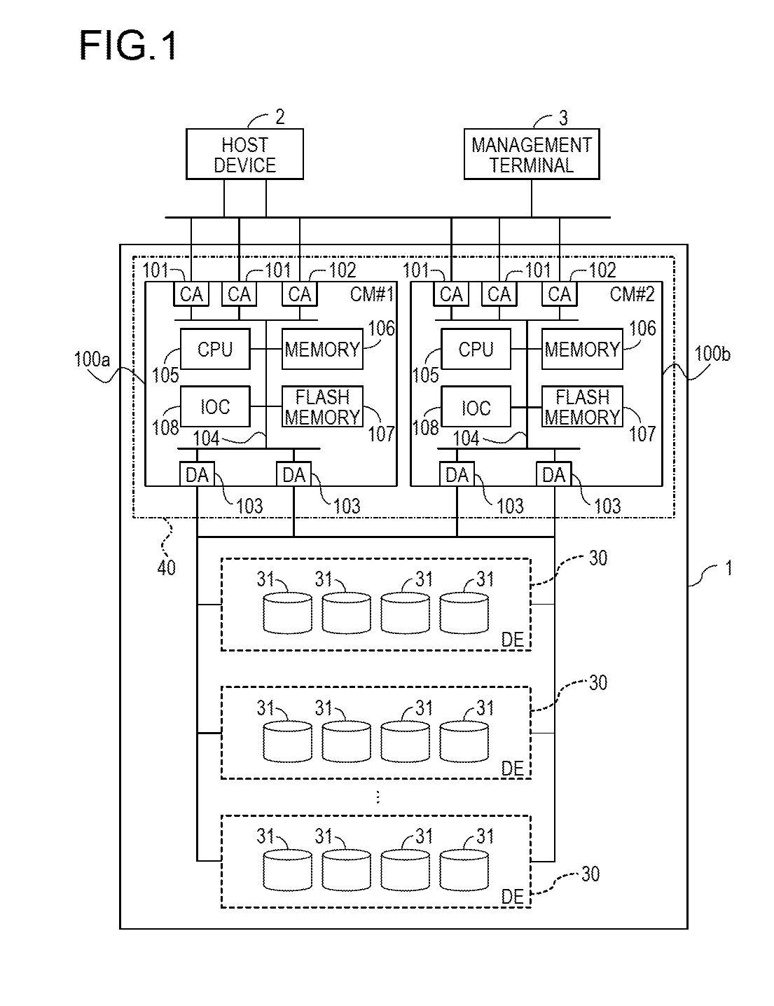

First, a storage system 1 including a storage control device 100 according to the embodiment will be described with reference to FIG. 1. FIG. 1 is a diagram illustrating an exemplary hardware configuration of the storage system 1 including the storage control device 100 according to the embodiment.

The storage system 1 forms a virtual storage environment by virtualizing a storage device 31 mounted in a drive enclosure (DE) 30. The storage system 1 provides a virtual volume to a host device 2 (server) as an upper level device.

The storage system 1 is communicably coupled with one or more (one in the example illustrated in FIG. 1) host devices 2. The host device 2 and the storage system 1 are interconnected by communication adapters (CAs) 101 and 102 to be described later.

The host device 2 is, for example, an information processing device having a server function and transmits/receives commands of the network attached storage (NAS) or the storage area network (SAN) to/from the storage system 1. The host device 2 writes/reads data into/from a volume provided by the storage system 1 by transmitting a storage access command such as write/read of NAS to the storage system 1.

Then, in accordance with an input/output request (e.g., a write request or a read request) performed for the volume by the host device 2, the storage system 1 performs a process such as data writing or reading for the storage device 31 corresponding to the volume. The input/output request from the host device 2 may be referred to as an I/O request.

Although one host device 2 is illustrated in the example of FIG. 1, without being limited thereto, two or more host devices 2 may be coupled with the storage system 1.

In addition, a management terminal 3 is communicably coupled with the storage system 1. The management terminal 3 is an information processing apparatus including an input device such as a keyboard or a mouse and a display, and allows a user such as a system administrator to input a variety of information. For example, the user inputs information on a variety of settings via the management terminal 3. The input information is transmitted to the host device 2 or the storage system 1.

As illustrated in FIG. 1, the storage system 1 includes a plurality (two in the present embodiment) of controller modules (CMs) 100a and 100b and one or more (three in the example of FIG. 1) drive enclosures 30.

Each drive enclosure 30 may accommodate one or more (four in the example of FIG. 1) storage devices 31 (physical disks) whose storage areas (real volumes or real storages) are provided to the storage system 1.

For example, the drive enclosure 30 includes a plurality of slots (not illustrated). By inserting the storage devices 31 in these slots, the real volume capacity may be changed appropriately. The plurality of storage devices 31 may be used to construct a redundant array of inexpensive disks (RAID).

The storage device 31 is a storage device such as an HDD or an SSD, which has a larger capacity than a memory 106 to be described later and stores therein a variety of data. In the following descriptions, a storage device may be referred to as a drive or a disk.

Each drive enclosure 30 is coupled with each of device adapters (DAs) 103 of the CM 100a and each of DAs 103 of the CM 100b. Thus, both the CMs 100a and 100b may access each drive enclosure 30 to perform a data writing or reading operation. That is, by coupling the CMs 100a and 100b with each storage device 31 in each drive enclosure 30, an access path to the storage device 31 is made redundant.

A controller enclosure 40 includes one or more (two in the example of FIG. 1) CMs 100a and 100b.

Each of the CMs 100a and 100b is a controller (storage control device) for controlling operations in the storage system 1 and performs a variety of controls such as a control of data access to the storage devices 31 in the drive enclosures 30, in accordance with an I/O command transmitted from the host device 2. The CMs 100a and 100b have a similar configuration. Hereinafter, the CMs are referred to as the CM 100a and the CM 100b to specify one of the plural CMs, and referred to as a CM 100 to refer to any of the CMs. In addition, the CMs 100a and 100b may be denoted by CM#1 and CM#2, respectively.

The CMs 100a and 100b are duplexed, and the CM 100a (CM#1) is typically a primary CM to perform a variety of controls. However, when the primary CM 100a is out of order, the secondary CM 100b (CM#2) acts as a primary CM and takes over the operations of the CM 100a.

The CMs 100a and 100b are coupled with the host device 2 via the CAs 101 and 102. Each of the CMs 100a and 100b receives an I/O request such as a write/read request, which is transmitted from the host device 2, and performs a control of the storage device 31 via the DA 103 or the like. In addition, the CMs 100a and 100b are communicably interconnected via an interface (not illustrated) such as the peripheral component interconnect express (PCIe).

As illustrated in FIG. 1, the CM 100 includes a central processing unit (CPU) 105, a memory 106, a flash memory 107, and an input/output controller (IOC) 108, in addition to the CAs 101 and 102 and the plurality (two in the example of FIG. 1) of DAs 103. The CAs 101 and 102, the DA 103, the CPU 105, the memory 106, the flash memory 107, and the IOC 108 are communicably interconnected via, for example, a PCIe interface 104.

Each of the CAs 101 and 102 receives data transmitted from, for example, the host device 2 or the management terminal 3 or transmits data output from the CM 100 to, for example, the host device 2 or the management terminal 3. That is, each of the CAs 101 and 102 controls data input/output with an external device such as the host device 2.

The CA 101 is a network adapter, such as a local area network (LAN) interface, communicably coupled with the host device 2 and the management terminal 3 via the NAS. The CA 101 of each CM 100 is coupled with, for example, the host device 2 by the NAS via a communication line (not illustrated) and performs reception of I/O requests, transmission/reception of data, and the like. In the example illustrated in FIG. 1, two CAs 101 are included in each of the CMs 100a and 100b.

The CA 102 is a network adapter, such as an international small computer system interface (iSCSI) interface or a fibre channel (FC) interface, communicably coupled with the host device 2 via the SAN. The CA 102 of Each CM 100 is coupled with, for example, the host device 2 by the SAN via a communication line (not illustrated) and performs reception of I/O requests, transmission/reception of data, and the like. In the example illustrated in FIG. 1, one CA 102 is included in each of the CMs 100a and 100b.

The DA 103 is an interface for communicably coupled with, for example, the drive enclosure 30 or the storage devices 31. The DA 103 is coupled with the storage devices 31 of the drive enclosure 30, and each CM 100 performs a control of access to the storage devices 31 in accordance with an I/O request received from the host device 2.

Each CM 100 performs writing or reading of data in or from the storage devices 31 via the DA 103. In the example illustrated in FIG. 1, two DAs 103 are included in each of the CMs 100a and 100b. In each of the CMs 100a and 100b, the drive enclosure 30 is coupled with each DA 103.

Thus, the storage devices 31 in the drive enclosure 30 may perform writing or reading of data in or from both the CMs 100a and 100b.

The flash memory 107 is a storage device for storing therein a program to be executed by the CPU 105, a variety of data, and the like.

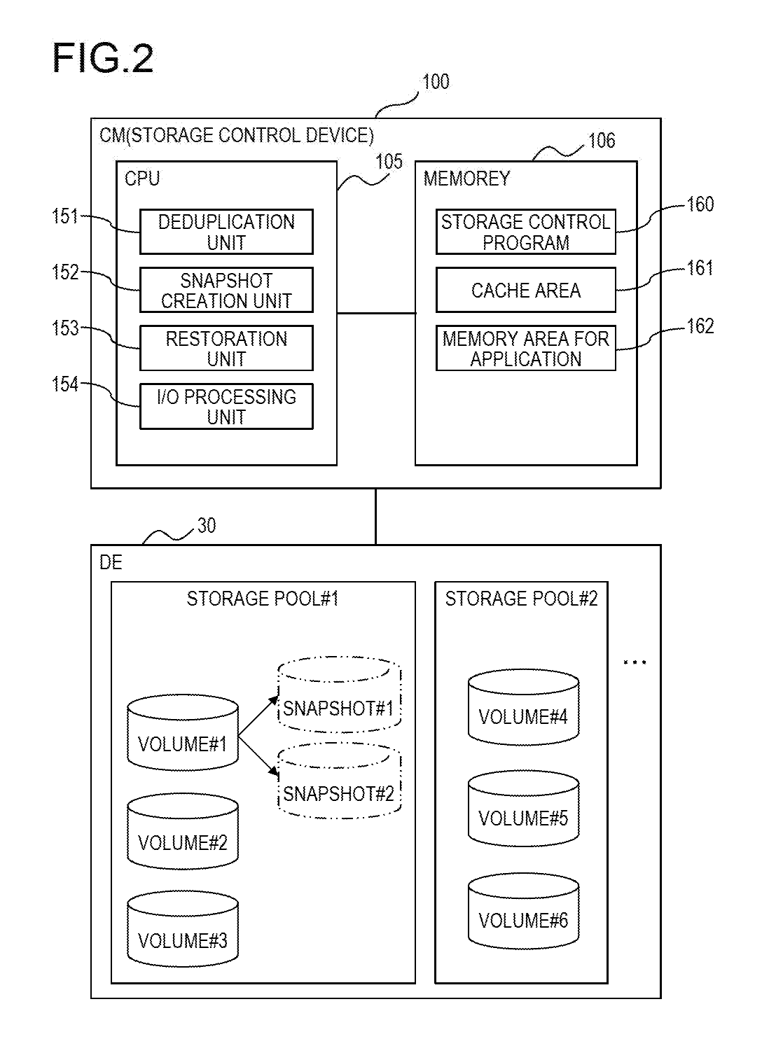

The memory 106 is a storage device for temporarily storing a variety of data and programs and includes a cache area 161 and a memory area 162 for application (see FIG. 2). The cache area 161 temporarily stores therein data received from the host device 2 or data to be transmitted to the host device 2. The memory area 162 for application temporarily stores therein data and programs when the CPU 105 executes an application program. For example, the application program is a storage control program 160 (see FIG. 2) to be executed by the CPU 105 to implement the storage control function according to the present embodiment. The storage control program 160 is stored in the memory 106 or the flash memory 107. The memory 106 is, for example, a random access memory (RAM) which has a higher access speed and a smaller capacity than the above-described storage device 31 (drive).

The IOC 108 is a controller for controlling data transmission within each CM 100 and implements direct memory access (DMA) transmission for transmitting data stored in the memory 106 with no intervention of the CPU 105.

The CPU 105 is a processor to perform a variety of controls and calculations, such as a multicore processor (multi-CPU). The CPU 105 implements a variety of functions by executing an operating system (OS) and programs stored in the memory 106, the flash memory 107, or the like.

Subsequently, a functional configuration of the storage control device 100 (CM) according to the present embodiment will be described with reference to FIG. 2. FIG. 2 is a diagram illustrating an exemplary functional configuration of the CM 100.

In the CM 100 according to the present embodiment, the CPU 105 functions as a deduplication unit 151, a snapshot creation unit 152, a restoration unit 153, and an I/O processing unit 154, as illustrated in FIG. 2, by executing the storage control program 160.

The storage control program 160 is provided in the form of being recorded in a portable non-transitory computer-readable recording medium such as a magnetic disk, an optical disk, a magneto-optic disk, or the like. Examples of the optical disk may include a compact disk (CD), a digital versatile disk (DVD), a blu-ray disk, or the like. Examples of the CD may include a CD read-only memory (CD-ROM), a CD-recordable/rewritable (CD-R/RW), or the like. Examples of the DVD may include a DVD-RAM, DVD-ROM, DVD-R, DVD+R, DVD-RW, DVD+RW, high definition DVD (HD DVD), or the like.

The CPU 105 reads the storage control program 160 from the above-described recording medium and stores the program in an internal storage device (e.g., the memory 106 or the flash memory 107) or an external storage device for later use. The CPU 105 may receive the storage control program 160 via a network (not illustrated) and stores the program in an internal storage device or an external storage device for later use.

The CM 100 according to the present embodiment is to control the storage devices 31 in the drive enclosures 30 and has both a data deduplication function by the deduplication unit 151 (deduplication engine) and a snapshot creation function by the snapshot creation unit 152 (snapshot creation engine).

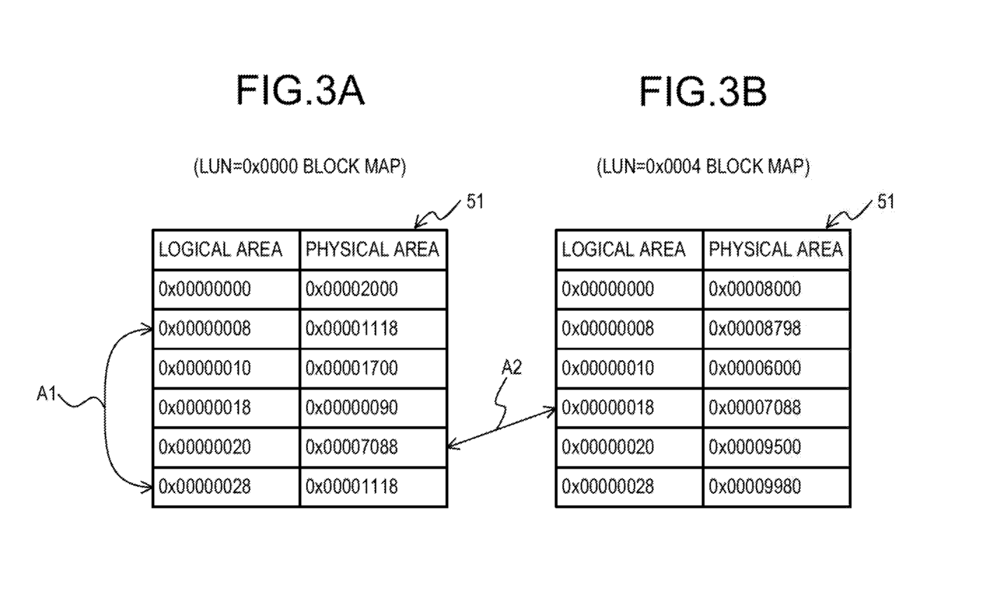

The deduplication unit 151 implements the data deduplication function to prevent each unit data stored in each storage device 31 from being duplicated. The deduplication unit 151 uses a block map 51 (mapping table) (see, e.g., FIG. 3A) to perform a deduplication process on unit data (referred to as to-be-written unit data) to be written in a deduplication volume. The block map 51 corresponds to map information indicating a physical area allocated to a logical area of each unit data with respect to the deduplication volume in the storage device 31. The block map 51 may be stored in the memory area 162 for application in the memory 106 or may be stored in the storage device 31. The logical area may be represented by a logical address (logical block address (LBA)). The physical area may be represented by a physical address (real address in each storage device 31). The block map 51 will be described in detail later with reference to FIGS. 3A, 3B, 5A to 7B, and 10A to 11B.

In the example illustrated in FIG. 2, storage pool#1, storage pool#2, . . . in the DE 30 (storage device 31) are units (deduplication units) of deduplication. The storage pool#1 includes three logical volumes (volume#1 to volume#3) as deduplication volumes, and the storage pool#2 includes three logical volumes (volume#4 to volume#6) as deduplication volumes.

In the storage pool#1, the block map 51 is created for each of volume#1 to volume#3. The block maps 51 are used to prevent data of volume#1 to volume#3 and data in the corresponding storage pool#1 from being duplicated. Similarly, in the storage pool#2, the block map 51 is created for each of volume#4 to volume#6. The block maps 51 are used to prevent data of volume#4 to volume#6 and data in the corresponding storage pool#2 from being duplicated.

Upon receiving a write request (data update request) for a deduplication volume from the host device 2, the deduplication unit 151 performs a duplication check to check whether or not the unit data (post-update data) to be written received from the host device 2 overlaps with existing data within the same storage pool (deduplication pool). When the post-update data overlaps with existing data, the deduplication unit 151 associates, in the block map 51 for the deduplication volume, a logical area of the object data of the write request with a physical area of the existing data. When the post-update data does not overlap with existing data, the deduplication unit 151 associates, in the block map 51 for the deduplication volume, the logical area of the object data of the write request with a newly allocated physical area and writes the to-be-written unit data in the newly allocated physical area.

In the present embodiment, the unit data (to-be-written unit data) on which the duplication check is performed may be a data block having the size of the unit (physical block unit: e.g., 512 B (bytes)) of writing in an HDD, SSD, or the like or may be a data block group (e.g., 4 kilobytes) including a plurality of data blocks.

Upon receiving a snapshot creation request for a deduplication volume from the host device 2, the snapshot creation unit 152 determines whether or not the deduplication volume (copy source) and a snapshot area (copy destination) belong to the same deduplication pool.

When the copy source and the copy destination do not belong to the same deduplication pool, that is, belong to different deduplication pools, the snapshot creation unit 152 performs a similar process to the snapshot creation process described above with reference to FIG. 17. That is, the snapshot creation unit 152 copies the pre-update unit data (pre-write unit data) of the deduplication volume into a snapshot area in a deduplication pool different from the deduplication pool to which the deduplication volume belongs. Thus, a snapshot of the deduplication volume is created.

When the copy source and the copy destination belong to the same deduplication pool, the snapshot creation unit 152 performs the following process. That is, the snapshot creation unit 152 copies the block map 51 for the deduplication volume, for which a snapshot is to be created, into a snapshot area in the deduplication pool to which the deduplication volume belongs, sequentially for each entry. Thus, the snapshot of the deduplication volume is created. Each entry of the block map 51 includes information related to one set of a logical area and a physical area which corresponds to each unit data.

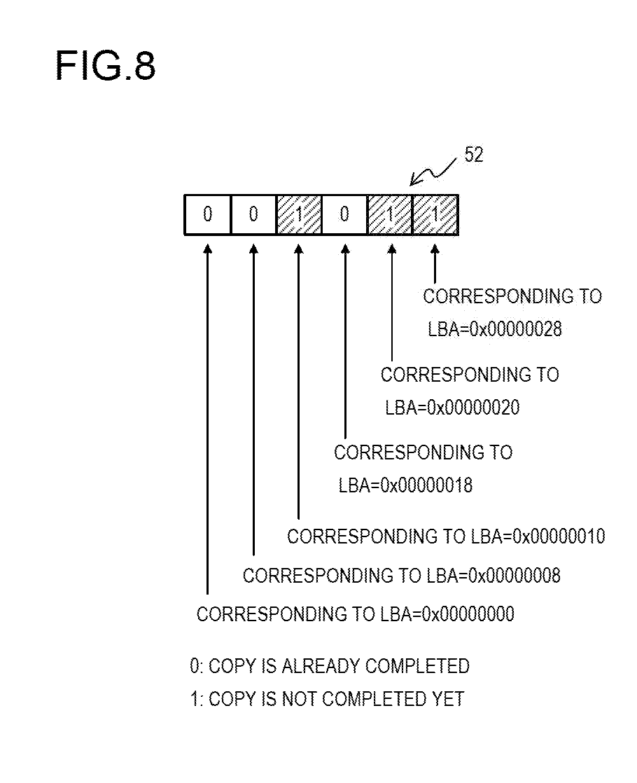

At this time, the snapshot creation unit 152 creates a bit map 52 (see FIG. 8) for managing a copy state of the block map 51 for the deduplication volume for which the snapshot is to be created. The bit map 52 has bits each corresponding to each unit data of the deduplication volume for which the snapshot creation request has been received. The bit map 52 manages, by each bit, copy completion/incompletion of one entry of the block map 51, which corresponds to each unit data. As will be described later with reference to FIG. 8, when the copy of the corresponding entry is not completed yet, the corresponding bit is set as “1”. When the copy of the corresponding entry is already completed, the corresponding bit is set as “0”. The bit map 52 may be stored in the memory area 162 for application in the memory 106 or in the storage device 31. An area of the bit map 52 is released when the copy of all entries of the block map 51 for the deduplication volume is completed.

As will be described below, the snapshot creation unit 152 copies the block map 51 for the deduplication volume into the snapshot area for each entry in accordance with the created bit map 52. At that time, the snapshot creation unit 152 determines whether or not the to-be-written unit data, which is received from the host device 2, is included in the deduplication volume under snapshot creation. When it is determined that the to-be-written unit data is not included in the deduplication volume under snapshot creation, the I/O processing unit 154 performs a normal write I/O process for the to-be-written unit data.

When it is determined that the to-be-written unit data is included in the deduplication volume under snapshot creation, the snapshot creation unit 152 determines whether or not the deduplication volume (copy source) and the snapshot area (copy destination) belong to the same deduplication pool.

When it is determined that the copy source and the copy destination do not belong to the same deduplication pool, that is, belong to different deduplication pools, the snapshot creation unit 152 performs a similar process to the process described above with reference to FIG. 17. That is, the snapshot creation unit 152 determines whether or not the pre-update unit data in a logical area in which the unit data (post-update data) is to be written is already copied. When it is determined that the pre-update unit data is not copied yet, the snapshot creation unit 152 creates a snapshot by copying the pre-update unit data into the snapshot area (management area), and the I/O processing unit 154 allocates a new physical area to the logical area and writes the to-be-written unit data in the allocated physical area. When it is determined that the pre-update unit data is already copied, the snapshot creation unit 152 does not copy the pre-update unit data, and the I/O processing unit 154 allocates a new physical area to the logical area and writes the to-be-written unit data in the allocated physical area.

When it is determined that the copy source and the copy destination belong to the same deduplication pool, the snapshot creation unit 152 refers to the bit map 52 for the deduplication volume of the copy source. When “1” indicating “copy is not completed yet” is set in a bit corresponding to the to-be-written unit data in the bit map 52, the snapshot creation unit 152 copies an entry of the block map 51, which corresponds to the to-be-written unit data, into the snapshot area. Then, the snapshot creation unit 152 sets, in the bit map 52, the bit corresponding to the to-be-written unit data as “0” indicating “copy is already completed”. Thereafter, the I/O processing unit 154 performs the normal write I/O process for the to-be-written unit data.

When “0” indicating “copy is already completed” is set in the bit corresponding to the to-be-written unit data in the bit map 52, the snapshot creation unit 152 skips the process of copying the entry of the block map 51 corresponding to the to-be-written unit data and the process of updating the bit map 52. Thereafter, the I/O processing unit 154 performs the normal write I/O process for the to-be-written unit data.

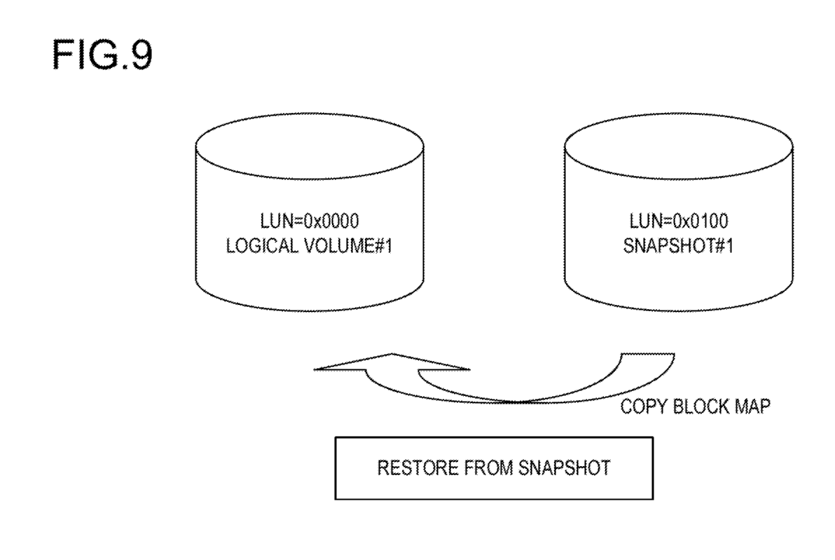

Upon receiving a restoration request for a deduplication volume, the restoration unit 153 restores the deduplication volume by copying the block map 51 (information in each entry) in the snapshot area into a restoration destination. A restoration process performed by the restoration unit 153 will be described later with reference to FIGS. 9 to 11B.

Next, operations of the storage control device 100 according to the present embodiment having the above-described functional configuration will be described with reference to FIGS. 3A to 11B.

First, a difference in operations between the above-described existing storage system and the storage system 1 according to the present embodiment will be described.

The copy source (deduplication volume) and the copy destination (snapshot area) may belong to the same storage pool or different storage pools in the above-described existing storage system. In contrast, in the present embodiment, the copy source and the copy destination belong to the same storage pool (deduplication pool).

In the storage system 1 according to the present embodiment, the creation of the snapshot of the deduplication volume is performed by copying the block map 51 for the deduplication volume of the copy source into the snapshot area of the snapshot destination volume.

In the above-described existing storage system, when creating the snapshot, the copy completion/incompletion of each unit data of the copy source is managed by the bit map having bits corresponding to the respective unit data. In contrast, in the storage control device 100 according to the present embodiment, when creating the snapshot of the deduplication volume, the copy completion/incompletion of each entry of the block map 51 is managed using the bit map 52 (see FIG. 8) having bits corresponding to the respective entries of the block map 51. The use of the bit map 52 may prevent an access of the host device 2 to the storage system 1 from being stopped into a standby mode during the block map 51 is being copied.

After the entire entries of the block map 51 are copied, the storage control device 100 manages an access to the copy source volume (deduplication volume) and an access to the snapshot volume (snapshot area) independently.

In the existing storage system, a process of restoration from the snapshot to the copy source is performed by physically copying differential data. In contrast, in the present embodiment, a process of restoration from the snapshot to the copy source volume is performed by the restoration unit 153 of the storage control device 100 to copy the block map 51 in the snapshot area into the copy source volume. At this time, in the storage system 1 according to the present embodiment, no physical copy of data is performed.

In the deduplication function, as described above, there exists a block map 51 indicating to which physical area a logical area for unit data of a predetermined size (e.g., 4 KB) is allocated. In the storage system 1 according to the present embodiment, when a snapshot of the deduplication volume is created, the deduplication unit 151 is requested to create the block map 51 having bits corresponding to the respective unit data in the deduplication volume. Accordingly, an overhead is reduced in data writing after the snapshot is created.

Now, a specific example of a structure of the block map 51 for the deduplication volume will be described with reference to FIGS. 3A and 3B. FIGS. 3A and 3B are diagrams illustrating examples of the block map 51 for two different deduplication volumes (logical volumes), respectively.

FIG. 3A illustrates a block map 51 for a logical volume, e.g., volume#1 of logical unit number (LUN)=0x0000. FIG. 3B illustrates a block map 51 for a logical volume, e.g., volume#2 of LUN=0x0004. In volume#1 illustrated in FIG. 3A, a physical area (physical address) “0x00001118” allocated to logical areas (logical addresses) “0x00000008” and “0x00000028” is duplicated (see an arrow A1). In addition, in volume#1 and volume#2 illustrated in FIGS. 3A and 3B, a physical area “0x00007088” allocated to logical areas “0x00000020” and “0x00000018”, respectively, is duplicated (see an arrow A2).

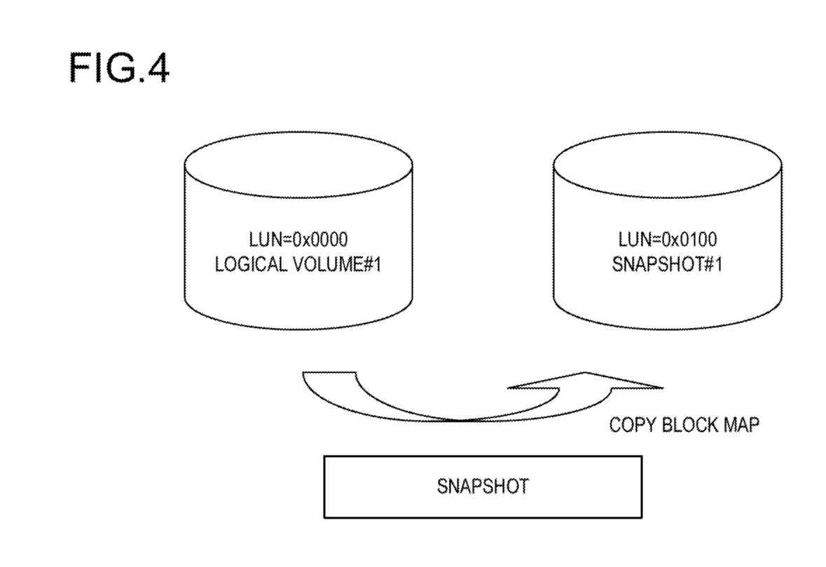

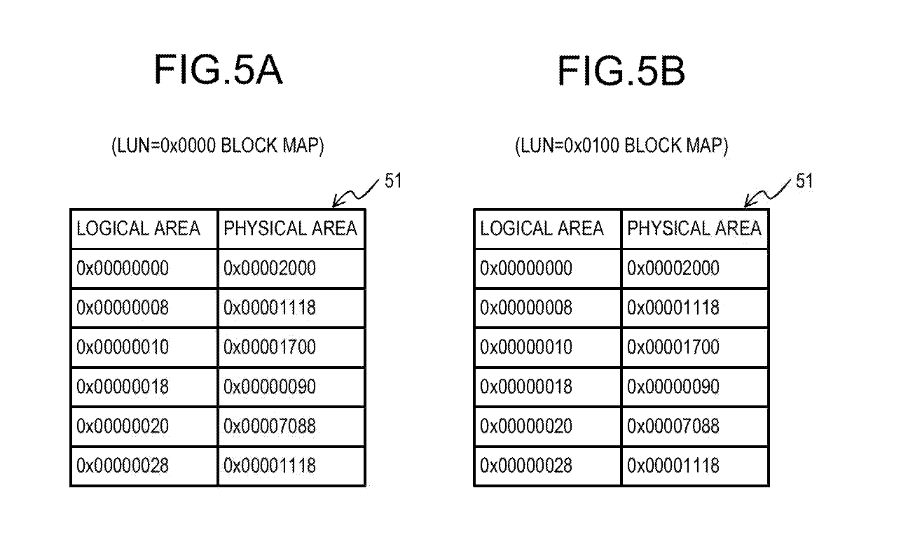

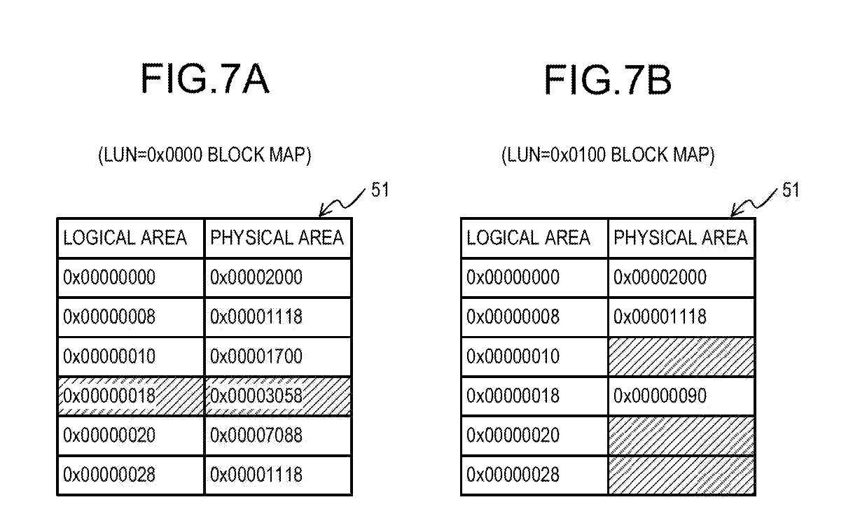

Subsequently, a snapshot creation operation performed by the snapshot creation unit 152 according to the present embodiment will be described with reference to FIGS. 4 to 8. FIGS. 4 to 8 are diagrams for explaining the snapshot creation operation according to the present embodiment. In particular, FIGS. 5A, 6A, and 7A are diagrams illustrating examples of the block map 51 for the deduplication volume. FIGS. 5B, 6B, and 7B are diagrams illustrating examples of the block map 51 as the snapshot of the deduplication volume, and correspond to FIGS. 5A, 6A, and 7A, respectively. FIG. 8 is a diagram illustrating an example of the bit map 52 corresponding to the block map 51 illustrated in FIG. 7B.

Here, for example, as illustrated in FIG. 4, the block map 51 for the copy source logical volume#1 of LUN=0x0000 (see FIGS. 3A and 5A) is copied into a copy destination snapshot area of LUN=0x0100 in the same storage pool (see FIG. 5B). Thus, a snapshot (snapshot#1) of the logical volume#1 is created in the snapshot area.

Since data of LUN=0x0100 is exactly identical to data of LUN=0x0000 of the copy source at the point of time when the creation of the snapshot is completed, a block map 51 identical to the block map 51 illustrated in FIG. 5A is created in LUN=0x0100, as illustrated in FIG. 5B.

Once the snapshot (copy of the block map 51) is created, the copy source and the copy destination are accessed independently. This assumes that a physical area separated from the physical area of the pre-update unit data is allocated and writing in deduplication is controlled to be performed for the separated physical area. This ensures that pre-write unit data (pre-update unit data) is prevented from being erased by overwriting.

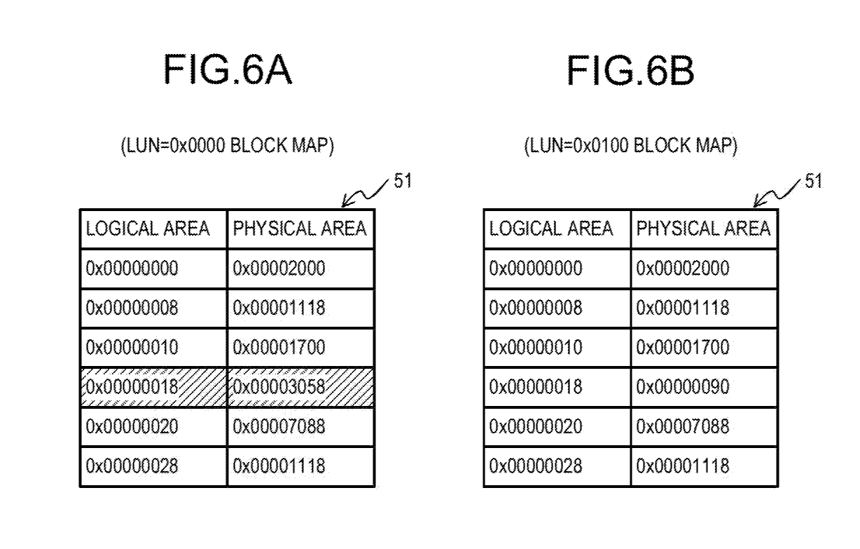

For example, when writing to the logical area (LBA) 0x00000018 of LUN=0x0000 is performed in a state of the block map 51 illustrated in FIG. 5A, the block map 51 illustrated in FIG. 5A is updated to such a block map as a block map 51 illustrated in FIG. 6A. For example, in FIG. 6A, instead of a physical area 0x00000090, a physical area 0x00003058 is newly allocated to LBA=0x00000018, and the to-be-written unit data is written in the corresponding physical area 0x00003058. At this time, as illustrated in FIG. 6B, the block map 51 as the snapshot of LUN=0x0100 is not updated at all.

When the normal snapshot is created in the existing storage system, only the above-described bit map having bits corresponding to the respective unit data is created, and the management of the copy completion/incompletion is performed for each unit data. Since the creation of the bit map having bits corresponding to respective unit data is performed at a high speed, the latency in host access is substantially zero.

When the block map is created in the deduplication (block map is created in a snapshot destination volume), since a mapping table (block map 51) has to be copied, it takes a time to make the copy. For example, when a snapshot of LUN of 400 GB is created, since a mapping table (block map 51) of 800 MB has to be copied, it takes a time of several seconds to several ten seconds to make the copy and the host device 2 suffers from an access delay.

Therefore, according to the present embodiment, bit map management is performed for the copy completion/incompletion of each entry of the block map 51 in the snapshot destination. Copy of the block map 51 is performed in sequence from the head entry. At that time, if a write request is received for an area (entry) for which copy is not completed yet, the copy-incomplete area (entry) is copied in preference, and a bit corresponding to the copy-incomplete area (entry) is updated in the bit map 52 from On (1) to Off (0). An area corresponding to an Off bit in the bit map 52 is skipped in the copy performed in sequence from the head entry since the copy of the corresponding entry is already completed.

For example, as illustrated in FIGS. 7A and 7B, when there is a write request to a fourth entry (logical area 0x00000018) from the top of the block map 51 for LUN=0x0000 at the point of time when two entries from the top of the block map 51 for LUN=0x0000 have been copied into LUN=0x0100, the present embodiment operates as follows.

That is, as illustrated in FIG. 7B, in preference to copying of the third entry (logical area 0x00000010) from the top of the block map 51 for LUN=0x0000, the fourth entry (logical area 0x00000018) from the top of the block map 51 for LUN=0x0000 is copied into LUN=0x0100. Along with this, as illustrated in FIG. 8, a bit (the fourth bit from left) corresponding to the fourth entry in the bit map 52 is updated from On (1) to Off (0). In addition, similar to the example illustrated in FIG. 6A, as illustrated in FIG. 7A, the physical area 0x00003058, instead of the physical area 0x00000090, is newly allocated to LBA=0x00000018, and the to-be-written unit data is written in the physical area 0x00003058. In this way, although the block map 51 is copied in order from the head entry of the volume, when an access to an area corresponding to a not-yet-copied entry of the block map 51 is made, the corresponding entry of the block map 51 is copied in preference.

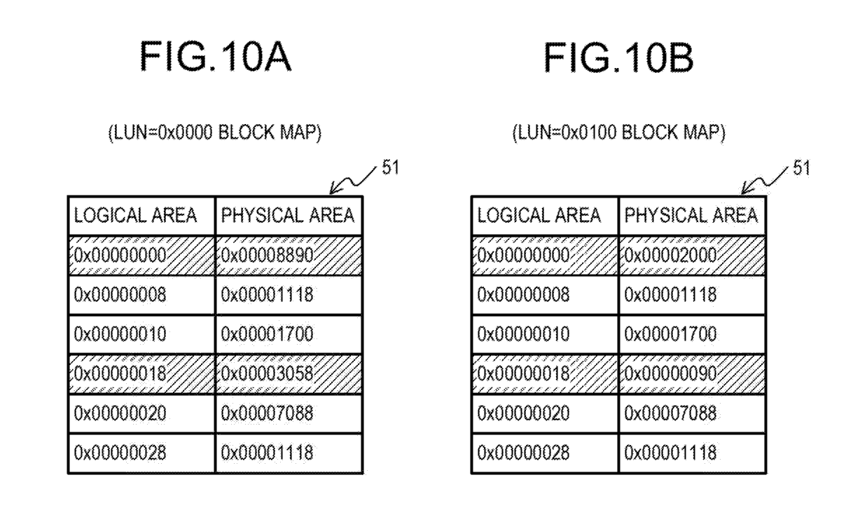

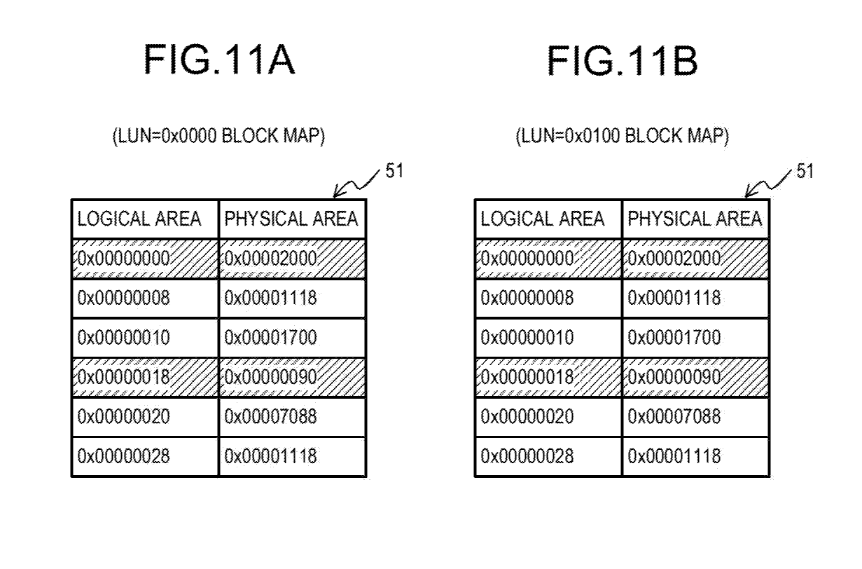

Subsequently, a restoration operation performed by the restoration unit 153 according to the present embodiment will be described with reference to FIGS. 9 to 11B. FIGS. 9 to 11B are diagrams for explaining the restoration operation according to the present embodiment. In particular, FIGS. 10A and 11A are diagrams illustrating examples of the block map 51 for the deduplication volume. FIGS. 10B and 11B are diagrams illustrating examples of the block map 51 as the snapshot of the deduplication volume, and correspond to FIGS. 10A and 11A, respectively.

A snapshot restoration process is a reverse process to the snapshot creation process. That is, in the snapshot restoration process, the block map 51 is simply copied from the snapshot destination volume to the deduplication volume of the copy source, but no physical copy of data is performed.

It is assumed that a state before the restoration is, for example, the state illustrated in FIGS. 10A and 10B. In the example illustrated in FIGS. 10A and 10B, differences between the copy source and the snapshot occur in the first and fourth entries from the top of the block map 51. Therefore, the restoration process (copying from the snapshot to the copy source) is performed for these two entries.

That is, when performing the restoration process for the block map 51 illustrated in FIGS. 10A and 10B, with respect to the first and fourth entries from the top of the block map 51, entries (physical areas) of the snapshot are copied as illustrated in FIGS. 11A and 11B. Thus, without performing the physical copy of data, the first and fourth entries (physical areas) from the top of the block map 51 for the copy source are restored as illustrated in FIG. 11A.

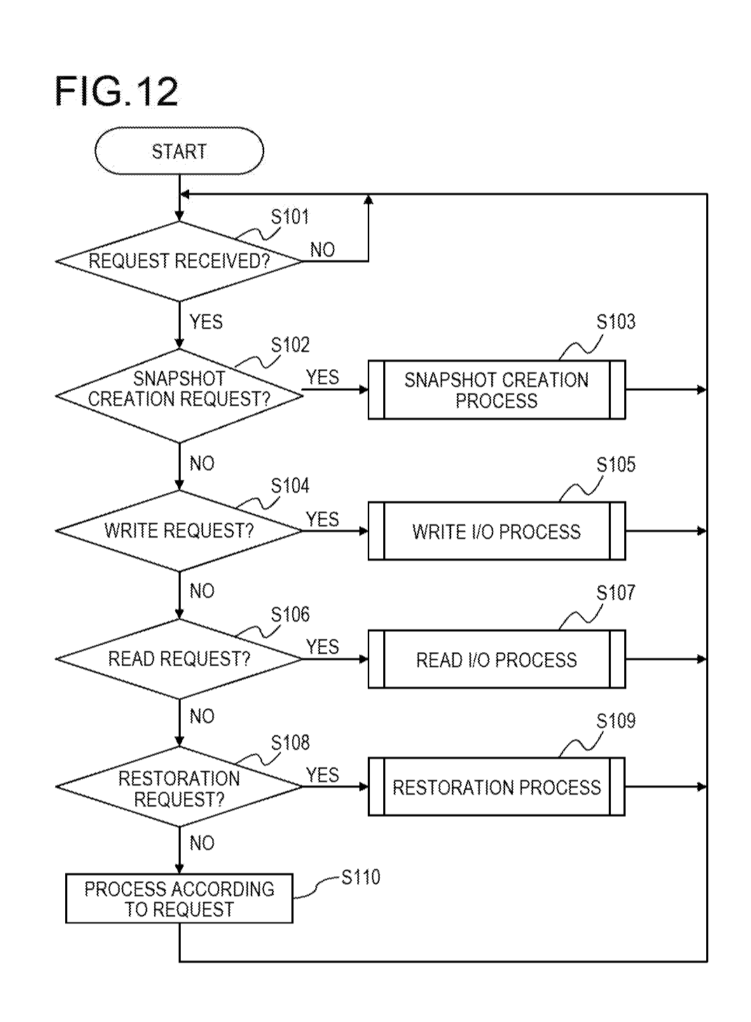

Next, a flow of operations for storage control according to the present embodiment will be described with reference to a flowchart illustrated in FIG. 12.

The CM 100 (CPU 105) according to the present embodiment waits for receiving a request from the host device 2 (server) (“NO” in S101). Upon receiving any request (“YES” in S101), the CPU 105 determines whether or not the received request is a snapshot creation request (S102).

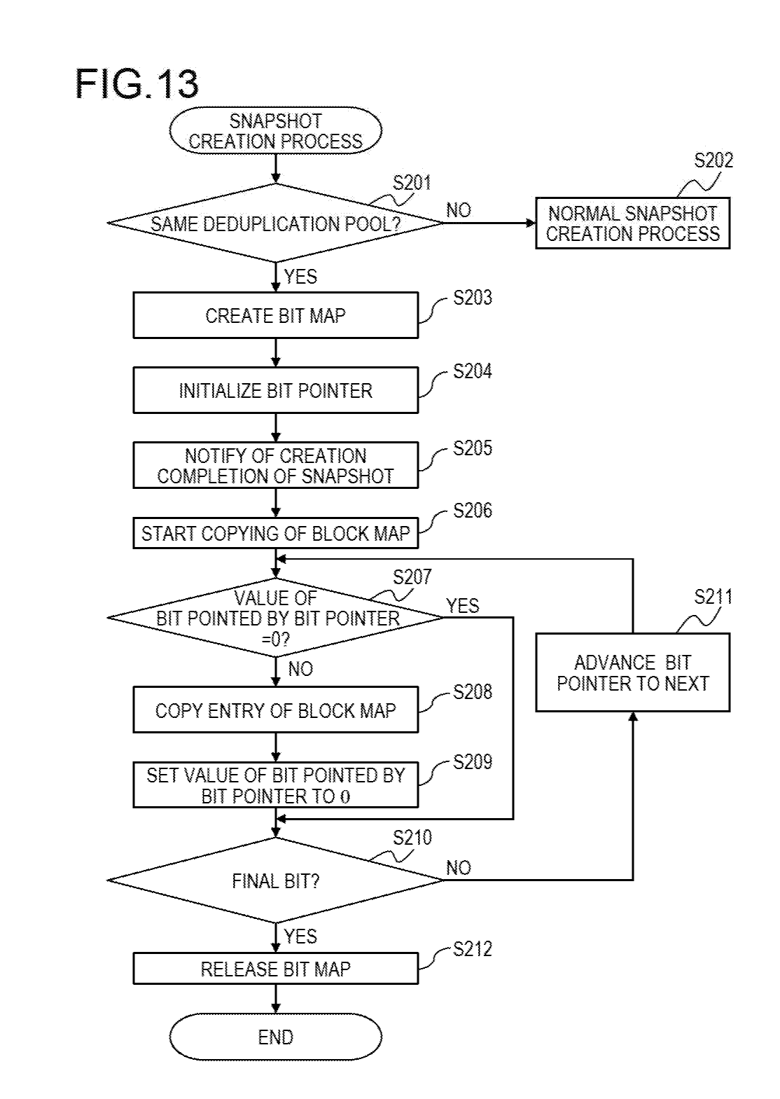

When it is determined that the received request is a snapshot creation request (“YES” in S102), the CPU 105 performs a snapshot creation process (S103). A sequence of the snapshot creation process will be described later with reference to FIG. 13. Thereafter, the CPU 105 returns to S101.

When it is determined that the received request is not a snapshot creation request (“NO” in S102), the CPU 105 determines whether or not the received request is a write request (S104).

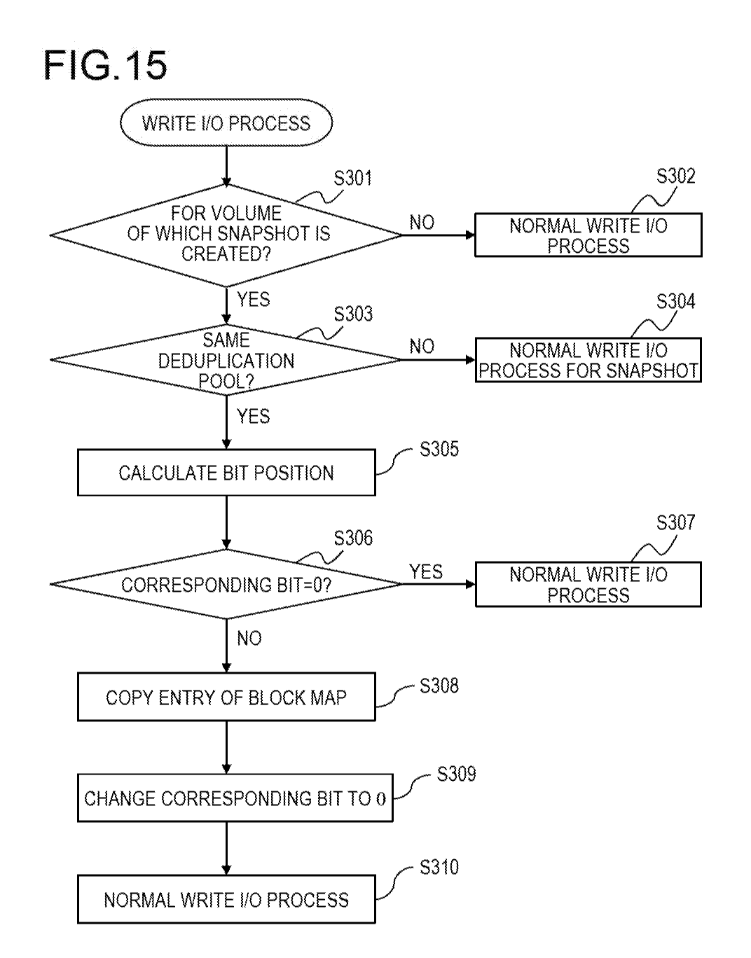

When it is determined that the received request is a write request (“YES” in S104), the CPU 105 performs a write I/O process (S105). A sequence of the write I/O process will be described later with reference to FIG. 15. Thereafter, the CPU 105 returns to S101.

When it is determined that the received request is not a write request (“NO” in S104), the CPU 105 determines whether or not the received request is a read request (S106).

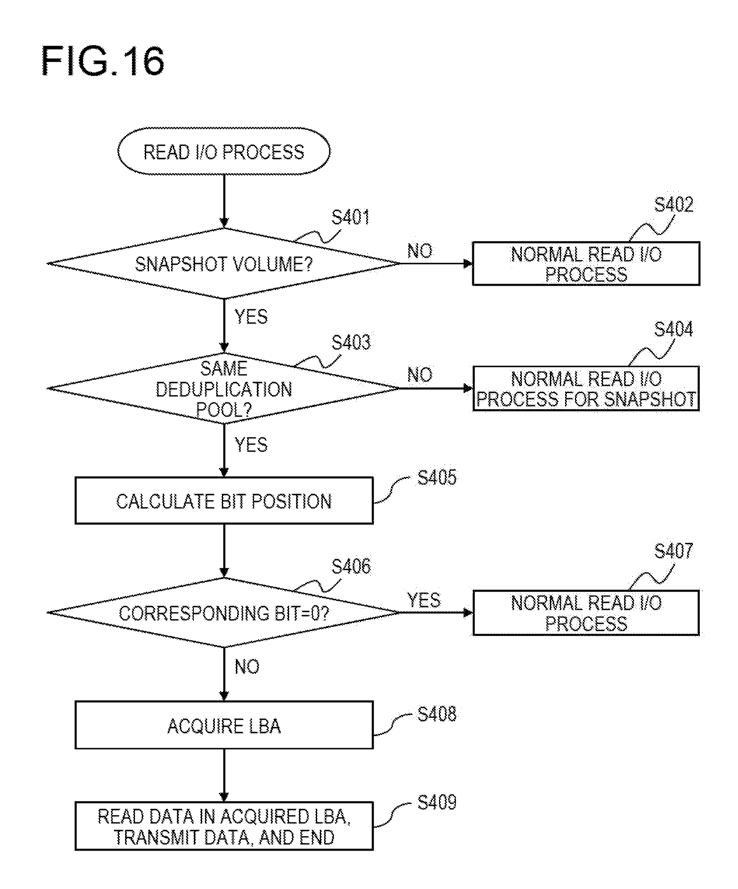

When it is determined that the received request is a read request (“YES” in S106), the CPU 105 performs a read I/O process (S107). A sequence of the read I/O process will be described later with reference to FIG. 16. Thereafter, the CPU 105 returns to S101.

When it is determined that the received request is not a read request (“NO” in S106), the CPU 105 determines whether or not the received request is a restoration request (S108).

When it is determined that the received request is a restoration request (“YES” in S108), the CPU 105 performs the restoration process described above with reference to FIGS. 9 to 11B (S109). Thereafter, the CPU 105 returns to S101.

When it is determined that the received request is not a restoration request (“NO” in S108), the CPU 105 performs a process in accordance with the received request (S110) and returns to S101.

Next, a flow of a process (snapshot creation process: S103 in FIG. 12) according to the present embodiment, which is performed upon receiving a snapshot creation request, will be described with reference to a flowchart illustrated in FIG. 13.

Upon receiving the snapshot creation request for a deduplication volume from the host device 2 (server), the snapshot creation unit 152 of the CPU 105 determines whether or not the deduplication volume (copy source) and a snapshot area (copy destination) belong to the same deduplication pool (S201).

When it is determined that the copy source and the copy destination do not belong to the same deduplication pool (“NO” in S201), the snapshot creation unit 152 performs a similar process to the snapshot creation process described above with reference to FIG. 17 (S202). That is, the snapshot creation unit 152 copies pre-update unit data of the deduplication volume into a snapshot volume (snapshot area) in a deduplication pool different from a deduplication pool to which the deduplication volume belongs. Thus, a snapshot of the deduplication volume is created.

When it is determined that the copy source and the copy destination belong to the same deduplication pool (“YES” in S201), the snapshot creation unit 152 creates the bit map 52 (see FIG. 8) to manage the copy completion/incompletion of the block map 51 for the deduplication volume for which the snapshot is created (S203). At this time, the snapshot creation unit 152 sets “1” in all bits of the bit map 52 to initialize the created bit map 52.

In addition, the snapshot creation unit 152 sets a bit pointer pointing a bit of the bit map 52, which corresponds to an entry of interest, to point a bit corresponding to the head (LBA=0) of the block map 51 for the deduplication volume (S204).

At this point, the CPU 105 notifies a user (the host device 2) of the creation completion of the snapshot of the deduplication volume in advance (S205), and starts a process of copying the block map 51 for the deduplication volume (S206).

Upon starting the copy process, first, the snapshot creation unit 152 determines whether or not a value of a bit pointed by the bit pointer in the bit map 52 is “0”, that is, whether or not copying of an entry corresponding to the bit pointer is completed (S207).

When it is determined that the value of a bit pointed by the bit pointer is “1”, that is, when the copying of the entry corresponding to the bit pointer is not completed yet (“NO” in S207), the snapshot creation unit 152 copies the entry of the block map 51 corresponding to the bit pointer into the copy destination (S208). Here, the copy destination is a snapshot area in the deduplication pool to which the deduplication volume belongs.

Then, the snapshot creation unit 152 updates the value of the bit pointed by the bit pointer from “1” (copy is not competed yet) to “0” (copy is competed) (S209).

When the value of a bit pointed by the bit pointer is “0”, that is, when the copying of the entry corresponding to the bit pointer is completed (“YES” in S207), or after the process of S209, the snapshot creation unit 152 performs a process of S210. That is, at S210, the snapshot creation unit 152 determines whether or not the bit pointer points a final bit corresponding to a final entry of the block map 51 for the deduplication volume (S210).

When it is determined that the bit pointer does not point a final bit corresponding to a final entry of the block map 51 for the deduplication volume (“NO” in S210), the snapshot creation unit 152 advances the bit pointer for the bit map 52, which points a bit corresponding to an entry of interest in the block map, to the next (S211). Thereafter, the snapshot creation unit 152 returns to S207.

When it is determined that the bit pointer points a final bit corresponding to a final entry of the block map 51 for the deduplication volume (“YES” in S210), the snapshot creation unit 152 determines that the creation of the snapshot of the deduplication volume is completed. That is, the snapshot creation unit 152 determines that copying of all entries of the block map 51 for the deduplication volume is completed, and releases the area of the bit map 52 (S212).

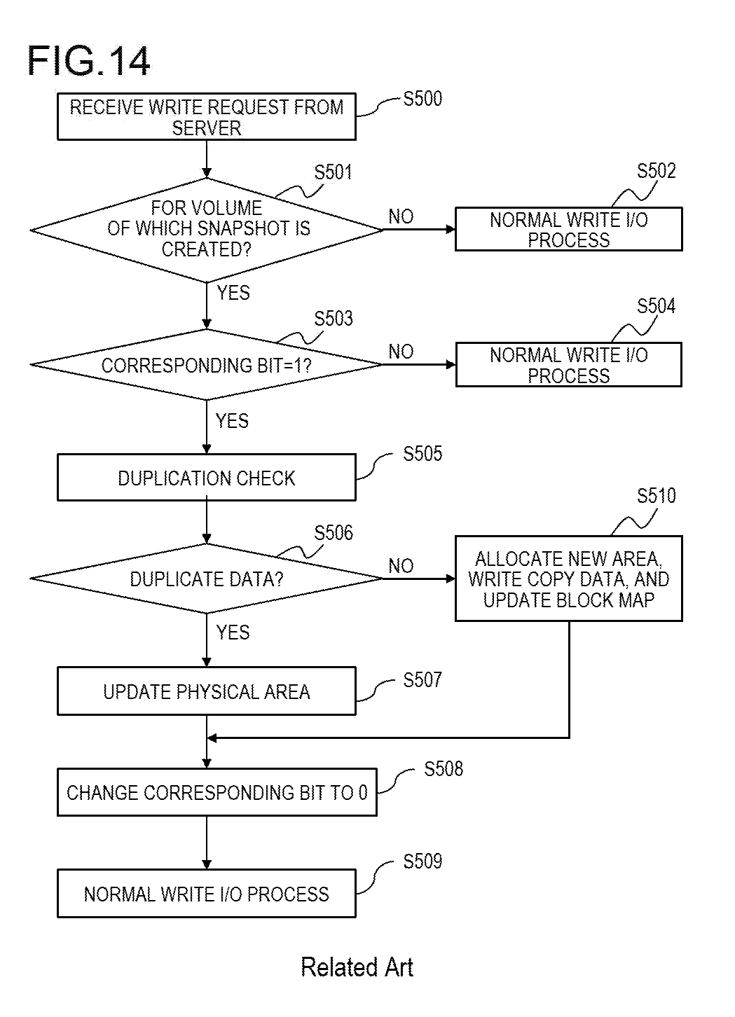

Next, a flow of a process performed by the existing storage system upon receiving a write request (a write I/O process) will be described with reference to a flowchart illustrated in FIG. 14, to be compared with exemplary operations (see FIG. 15) according to the present embodiment.

In the above-described existing storage system, upon receiving a write request from a server (S500), it is determined whether or not the write request is for a volume (copy source volume) of which a snapshot has been created (S501).

When it is determined that the write request is not for a volume of which a snapshot has been created (“NO” in S501), a normal write I/O process in response to the write request is performed (S502).

When it is determined that the write request is for a volume of which a snapshot has been created (“YES” in S501), a bit map for the snapshot, which has bits corresponding to respective unit data, is checked, and it is determined whether or not a bit corresponding to unit data of the write destination, to which data is written in response to the write request, is “1” (S503).

When it is determined that the corresponding bit is not “1”, that is, when the corresponding bit is “0” (“NO” in S503), it is determined that the unit data (pre-update unit data) of the write destination is already copied into a snapshot area (snapshot volume). Then, a normal write I/O process in response to the write request is performed (S504).

When it is determined that the corresponding bit is “1” (“YES” in S503), it is determined that the unit data (pre-update unit data) of the write destination is not copied yet into the snapshot area. In this case, a duplication check is performed, that is, it is determined whether or not the pre-update unit data to be copied from the copy source volume into the snapshot area is duplicate data which overlaps with existing data (S505).

As a result of the duplication check, when the pre-update unit data is duplicate data (“YES” in S506), in the block map in the snapshot volume, a physical area corresponding to a write position (LBA) is updated to a physical area (physical address) of the existing duplicate data (S507).

Then, the corresponding bit in the bit map for the snapshot, which has bits corresponding to respective unit data, is changed from “1” (not yet copied) to “0” (already copied) (S508). Thereafter, to-be-written unit data which is to be written in response to the write request is received from the server, and a normal write I/O process is performed (S509).

As a result of the duplication check, when the pre-update unit data is not duplicate data (“NO” in S506), a new area (physical address) is allocated, and the pre-update unit data is copied and written in the allocated new area. Thereafter, the block map in the snapshot volume is updated (S510), and then, the process proceeds to S508.

S501 and S503 correspond to the snapshot determination process (S2) in the existing storage system described above with reference to FIG. 17. In addition, S505 and S508 correspond to the data deduplication process (S3) in the existing storage system described above with reference to FIG. 17.

Next, a flow of a process (write I/O process: S105 in FIG. 12) according to the present embodiment, which is performed upon receiving a write request, will be described with reference to a flowchart illustrated in FIG. 15.

Upon receiving a write request for a deduplication volume from the host device 2 (server), the I/O processing unit 154 of the CPU 105 determines whether or not the write request is for a volume of which a snapshot has been created (S301).

When it is determined that the write request is not for a volume of which a snapshot has been created (“NO” in S301), the I/O processing unit 154 performs a normal write I/O process in response to the write request (S302) with the deduplication process by the deduplication unit 151.

When it is determined that the write request is for a volume of which a snapshot has been created (“YES” in S301), the CPU 105 determines whether or not the deduplication volume (copy source) and a snapshot area (copy destination) belong to the same deduplication pool (S303).

When it is determined that the copy source and the copy destination do not belong to the same deduplication pool (“NO” in S303), the CPU 105 performs a normal write I/O process for a snapshot in a different deduplication pool (S304).

When it is determined that the copy source and the copy destination belong to the same deduplication pool (“YES” in S303), the snapshot creation unit 152 calculates a bit position in the bit map 52 (an entry position in the block map 51), which corresponds to a write position at which data is to be written in response to the write request (S305).

The snapshot creation unit 152 determines whether or not a value of the corresponding bit is “0” (copy is completed) by referring to a value of a bit at the calculated bit position (a value of the corresponding bit) in the bit map 52 (S306).

When it is determined that the value of the corresponding bit is “0” (copy is completed) (“YES” in S306), the I/O processing unit 154 performs a normal write I/O process in response to the write request (S307) with the deduplication process by the deduplication unit 151.

When it is determined that the value of the corresponding bit is “1” (copy is not completed yet) (“NO” in S306), the snapshot creation unit 152 copies an entry of the block map 51 for the copy source volume corresponding to the corresponding bit position into the block map 51 in the copy destination volume (snapshot area) (S308).

Then, the snapshot creation unit 152 sets a value of the bit at the corresponding bit position in the bit map 52 from “1” (copy is not completed yet) to “0” (copy is completed) (S309).

Thereafter, the I/O processing unit 154 performs a normal write I/O process in response to the write request (S310) with the deduplication process by the deduplication unit 151.

Next, a flow of a process (read I/O process: S107 in FIG. 12) according to the present embodiment, which is performed upon receiving a read request, will be described with reference to a flowchart illustrated in FIG. 16.

Upon receiving a read request from the host device 2 (server), the I/O processing unit 154 of the CPU 105 determines whether or not the read request is for a snapshot volume (copy destination volume) (S401).

When it is determined that the read request is not for a snapshot volume (“NO” in S401), the I/O processing unit 154 performs a normal write I/O process in response to the read request (S402).

When it is determined that the read request is for a snapshot volume (“YES” in S401), the CPU 105 determines whether or not the deduplication volume (copy source) and a snapshot area (copy destination) belong to the same deduplication pool (S403).

When it is determined that the copy source and the copy destination do not belong to the same deduplication pool (“NO” in S403), the CPU 105 performs a normal read I/O process for a snapshot in a different deduplication pool (S404).

When it is determined that the copy source and the copy destination belong to the same deduplication pool (“YES” in S403), the snapshot creation unit 152 calculates a bit position in the bit map 52 (an entry position in the block map 51), which corresponds to a read position from which data is to be read in response to the read request (S405).

The snapshot creation unit 152 determines whether or not a value of the corresponding bit is “0” (copy is completed) by referring to a value of a bit at the calculated bit position (a value of the corresponding bit) in the bit map 52 (S406).

When it is determined that the value of the corresponding bit is “0” (copy is completed) (“YES” in S406), the I/O processing unit 154 performs a normal read I/O process in response to the read request (S407).

When it is determined that the value of the corresponding bit is “1” (copy is not completed yet) (“NO” in S406), the I/O processing unit 154 reads an entry of the block map 51 for the copy source volume, which corresponds to the corresponding bit position, and acquires a logical area (LBA) at the corresponding bit position (S408).

Then, the I/O processing unit 154 reads data in the acquired LBA, transmits the read data to the host device 2, and terminates the I/O process (S409).

As described above, according to the present embodiment, the snapshot creation process for the deduplication volume is implemented by a process of copying a block map 51 (a mapping table held for each deduplication volume and indicating physical areas). Therefore, the snapshot creation process is completed when the block map 51 is copied.

According to the present embodiment, to allow an access to a copy source volume during the copying of the block map 51, a bit map 52 indicating the copy completion/incompletion for each entry of the block map 51 is created. At this time, although the block map 51 is copied sequentially from the head (head entry) of the volume, when an access to an area into which an entry of the block map 51 is not copied yet is conducted, a corresponding entry of the block map 51 is copied in preference by using the bit map 52.

Thus, it is possible to implement optimized functions by combining the deduplication function and the snapshot creation function, without causing deterioration of the performance of the storage device 31.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. A storage control device, comprising:
a memory; and
a processor coupled with the memory and the processor configured to:
perform a deduplication process for avoiding duplication of first unit data among unit data of a deduplication volume in a storage device on basis of map information for the deduplication volume upon receiving a write request for writing write data to a write destination in the first unit data, each unit data of the deduplication volume being allocated with a logical area, the map information including an entry corresponding to each unit data of the deduplication volume, the entry indicating a physical area allocated to the logical area of each unit data; and
create, upon receiving a request for creating a snapshot of the deduplication volume, the snapshot by copying the map information into a snapshot area.

2. The storage control device according to claim 1, wherein
the processor is configured to:
create a bit map which has a bit corresponding to each entry of the map information, the bit indicating whether a copy of each entry of the map information is completed or not completed yet; and
copy the map information into the snapshot area on basis of the created bit map.

3. The storage control device according to claim 2, wherein
the processor is configured to:
determine, upon receiving the write request while creating the snapshot, whether a first bit of the bit map indicates that a copy of a first entry of the map information is completed, the first bit corresponding to the first entry, the first entry corresponding to the first unit data; and
copy the first entry into the snapshot area upon determining that the first bit indicates that a copy of the first entry is not completed yet and set the first bit to indicate that a copy of the first entry is completed.

4. The storage control device according to claim 2, wherein
the processor is configured to:
determine, upon receiving the write request while creating the snapshot, whether a first bit of the bit map indicates that a copy of a first entry of the map information is completed, the first bit corresponding to the first entry, the first entry corresponding to the first unit data; and
skip a copy of the first entry into the snapshot area upon determining that the first bit indicates that a copy of the first entry is completed.

5. The storage control device according to claim 2, wherein
the processor is configured to:
release a first storage area when the copy of the map information is completed, the first storage area storing therein the bit map.

6. The storage control device according to claim 1, wherein
the deduplication volume belongs to one of a plurality of storage pools,
the snapshot area belongs to one of the plurality of storage pools, and
the processor is configured to:
create, when the deduplication volume and the snapshot area belong to a same storage pool, the snapshot by copying the map information into the snapshot area.

7. The storage control device according to claim 1, wherein
the deduplication volume belongs to one of a plurality of storage pools,
the snapshot area belongs to one of the plurality of storage pools, and
the processor is configured to:
create, when the deduplication volume and the snapshot area belong to different deduplication unit storage pools, a snapshot of the deduplication volume by copying the first unit data into the snapshot area before writing the write data to the write destination.

8. The storage control device according to claim 1, wherein
the processor is configured to:
restore, upon receiving a request for restoring the deduplication volume, the deduplication volume by copying the map information stored in the snapshot area into a restoration destination.

9. A non-transitory computer-readable recording medium having stored therein a program that causes a computer to execute a process, the process comprising:
performing a deduplication process for avoiding duplication of first unit data among unit data of a deduplication volume in a storage device on basis of map information for the deduplication volume upon receiving a write request for writing write data to a write destination in the first unit data, each unit data of the deduplication volume being allocated with a logical area, the map information including an entry corresponding to each unit data of the deduplication volume, the entry indicating a physical area allocated to the logical area of each unit data; and
creating, upon receiving a request for creating a snapshot of the deduplication volume, the snapshot by copying the map information into a snapshot area.

10. The non-transitory computer-readable recording medium according to claim 9, the process comprising:
creating a bit map which has a bit corresponding to each entry of the map information, the bit indicating whether a copy of each entry of the map information is completed or not completed yet; and
copying the map information into the snapshot area on basis of the created bit map.

11. The non-transitory computer-readable recording medium according to claim 10, the process comprising:
determining, upon receiving the write request while creating the snapshot, whether a first bit of the bit map indicates that a copy of a first entry of the map information is completed, the first bit corresponding to the first entry, the first entry corresponding to the first unit data; and
copy the first entry into the snapshot area upon determining that the first bit indicates that a copy of the first entry is not completed yet and set the first bit to indicate that a copy of the first entry is completed.

12. The non-transitory computer-readable recording medium according to claim 10, the process comprising:
determining, upon receiving the write request while creating the snapshot, whether a first bit of the bit map indicates that a copy of a first entry of the map information is completed, the first bit corresponding to the first entry, the first entry corresponding to the first unit data; and
skipping a copy of the first entry into the snapshot area upon determining that the first bit indicates that a copy of the first entry is completed.

13. The non-transitory computer-readable recording medium according to claim 10, the process comprising:
releasing a first storage area when the copy of the map information is completed, the first storage area storing therein the bit map.

14. The non-transitory computer-readable recording medium according to claim 9, wherein
the deduplication volume belongs to one of a plurality of storage pools,
the snapshot area belongs to one of the plurality of storage pools, and
the process comprises:
creating, when the deduplication volume and the snapshot area belong to a same storage pool, the snapshot by copying the map information into the snapshot area.

15. The non-transitory computer-readable recording medium according to claim 9, wherein
the deduplication volume belongs to one of a plurality of storage pools,
the snapshot area belongs to one of the plurality of storage pools, and
the process comprises:
creating, when the deduplication volume and the snapshot area belong to different deduplication unit storage pools, a snapshot of the deduplication volume by copying the first unit data into the snapshot area before writing the write data to the write destination.

16. The non-transitory computer-readable recording medium according to claim 9, the process comprising:
restoring, upon receiving a request for restoring the deduplication volume, the deduplication volume by copying the map information stored in the snapshot area into a restoration destination.
